(19) United States
(12) Patent Application Publication
(10) Pub. No.: US 2021/0345214 A1
(43) Pub. Date: Nov. 4, 2021

(54) Radio Area Re-Selection for UAV in Cellular Networks

(71) Applicant: Telefonaktiebolaget LM Ericsson (publ), Stockholm (SE)

(72) Inventors: Jens Poscher, Aachen (DE); Stefan Eichinger, Pulheim (DE); Ralph Detke, Herzogenrath (DE); Pedro Tercero, Aachen (DE)

(21) Appl. No.: 17/259,723

(22) PCT Filed: Jul. 26, 2018
(86) PCT No.: PCT/EP2018/070268

§ 371 Date: Jan. 12, 2021

(51) Int. Cl. H04W 36/32; H04W 48/14; H04W 48/16; H04W 48/20; H04W 36/00

(52) U.S. Cl. CPC H04W 36/32; H04W 48/14; H04W 36/0061; H04W 48/20; H04W 48/16

(57) ABSTRACT

A method, apparatus, and computer program for assisting an unmanned aerial vehicle, UAV, (10) in performing serving radio area re-selection is presented. The UAV (10) is connected via a serving radio area to a cellular network and further is associated with an UAV-Application Server, UAV-AS, (100). The method is performed by the UAV-AS (100) and comprises receiving a request for allocating a flight path for use by the UAV (10) for traveling to a destination point and determining, after allocation of a flight path, a list of radio areas suitable as serving radio area along the allocated flight path and providing the list of radio areas to the requestor to assist the UAV (10) in performing serving radio area re-selection. A method performed by the UAV (10) comprises receiving a request to travel to a destination point and receiving, from the UAV-AS (100) after a flight path has been allocated, a list of radio areas suitable as serving radio area along the allocated flight path and performing serving radio area re-selection to a radio area from the list of radio areas for staying connected to the cellular network while traveling along the allocated flight path.

### TECHNICAL FIELD

The present invention relates to telecommunications and in particular to a system, method, node and computer program for an unmanned aerial vehicle, UAV, to perform serving radio area re-selection while traveling and for assistance to the UAV in performing the serving radio area re-selection by an UAV-application server, UAV-AS.

### BACKGROUND

New delivery services or emergency services will require specific unmanned aerial vehicle, UAV, to transport products or to perform surveillance.

An architecture presented here is based on a dedicated UAV-AS, that is used by any UAV using a specific cellular network when the UAV is activated. The UAV-AS is under the administrative domain of the operator and is automatically detected and connected to the cellular network, when the UAV-AS is taken into service.

Today's terrestrial radio network planning and optimization considers coverage, capacity requirements and quality targets, depending on several factors like the environment and other boundary conditions such as topography, available frequencies etc. The current focus is on a service to objects on the ground or ground-near, or in buildings.

However, as sketched in FIG. 1, the situation is very different for a UAV flying at higher altitudes. A UAV at high altitude will see many more radio areas than a ground-based UE. Due to lack of obstacles, a reach of a radio area is much higher and is much more dependent on weather conditions than on a ground.

This results into the situation, that radio areas do not appear in a same pattern as perceived by a ground-based UE. A UAV sees many more radio areas and radio areas are much longer in reach. A UAV 10 is connected to a cellular network via a serving radio area. However, due to the altitude of a UAV flight path, there are many interfering or alternative radio areas.

A UAV may be flying from location A to location B at a certain height. Thus, this UAV will face several handovers between radio areas, serving radio area must be re-selected much more often. Due to this, a high amount of signaling is triggered, the UAV is active unnecessary often, and this reducing the charging level of the UAV power supply. This signaling impacts also the network performance of the cellular networks for other ground-based traffic.

The frequent handover or radio area re-selections are also influencing negatively the user experience for UAV services. In a worst case, a fast flying UAV may not have enough time to succeed the handover or radio area re-selection procedures as the UAV may already detect more upcoming radio areas when traveling to a destination.

### SUMMARY

There is a clear need for a method and a corresponding apparatus for an UAV to perform an optimized serving radio area re-selection while traveling and for an UAV-AS assisting the UAV to perform such optimized serving radio area re-selection.

This object is achieved by the independent claims. Advantageous embodiments are described in the dependent claims.

According to an exemplary aspect of the invention, a method for assisting an unmanned aerial vehicle, UAV, in performing serving radio area re-selection is provided. The UAV is connected via a serving radio area to a cellular network and further is associated with an UAV-Application Server, UAV-AS. The method is performed by the UAV-AS and comprises receiving a request for allocating a flight path for use by the UAV for traveling to a destination point, determining, after allocation of a flight path, a list of radio areas suitable as serving radio area along the allocated flight path, and providing the list of radio areas to the requestor to assist the UAV in performing serving radio area re-selection.

According to a further exemplary aspect of the invention, a method for performing serving radio area re-selection by an unmanned aerial vehicle, UAV, is provided. The UAV is connected via a serving radio area to a cellular network and further is associated with an UAV-Application Server, UAV-AS. The method is performed by the UAV and comprises receiving a request to travel to a destination point, receiving, from the UAV-AS after a flight path has been allocated, a list of radio areas suitable as serving radio area along the allocated flight path, and performing serving radio area re-selection to a radio area from the list of radio areas for staying connected to the cellular network while traveling along the allocated flight path.

According to a further exemplary aspect of the invention, an Application Server, UAV-AS adapted for assisting an unmanned aerial vehicle, UAV, in performing serving radio area re-selection is provided. The UAV is connected via a serving radio area to a cellular network and further is associated with the UAV-AS. The UAV-AS is adapted to receiving a request for allocating a flight path for use by the UAV for traveling to a destination point, determining, after allocation of a flight path, a list of radio areas suitable as serving radio area along the allocated flight path, and providing the list of radio areas to the requestor to assist the UAV in performing serving radio area re-selection.

According to a further exemplary aspect of the invention, an unmanned aerial vehicle, UAV, adapted for performing serving radio area re-selection is provided. The UAV is connected via a serving radio area to a cellular network and further is associated with an UAV-Application Server, UAV-AS. The UAV is adapted to receiving a request to travel to a destination point, receiving, from the UAV-AS (100) after a flight path has been allocated, a list of radio areas suitable as serving radio area along the allocated flight path, and performing serving radio area re-selection to a radio area from the list of radio areas for staying connected to the cellular network while traveling along the allocated flight path.

According to a further exemplary aspect of the invention, a system adapted for providing assistance information from an UAV-Application Server, UAV-AS, to an unmanned aerial vehicle, UAV, for performing serving radio area re-selection is provided. The UAV is connected via a serving radio area to a cellular network and further being associated with the UAV-AS. The system comprises a UAV-AS and one or more UAV.

Also provided is a computer program product comprising program code portions to perform the steps of any of the methods presented herein when executed on one or more processors. The computer program product may be stored on computer readable recording medium such as a semiconductor/flash memory, DVD, and so on. The computer program product may also be provided for download via a communication connection.

The foregoing and other objects, features and advantages of the present invention will become more apparent in the following detailed description of embodiments of the invention illustrated in the accompanying drawings.

### BRIEF DESCRIPTION OF THE DRAWINGS

Further characteristics and advantages of the invention will become better apparent from the detailed description of particular, but not exclusive embodiments, illustrated by way of non-limiting examples in the accompanying drawings, wherein:

FIG. 1 shows a diagram illustrating a radio area reachability situation for a ground-based UE in comparison to a UAV;

FIG. 2 shows an illustration of UAV flight path situation when traveling from A to B, crossing several to radio area coverages;

FIG. 3 shows a block diagram in a UAV for serving radio area re-selection when traveling from a starting point to a destination point;

FIG. 4 show a first block diagram in a UAV-AS for receiving measurement reports from a UAV while traveling and maintain a database;

FIG. 5 show a second block diagram in a UAV-AS for assisting a UAV in radio area re-selection while traveling;

FIG. 6 shows an exemplary composition of a computing unit configured to execute a UAV-AS according to the present disclosure;

FIG. 7 shows an exemplary composition of a computing unit configured to execute a UAV according to the present disclosure;

FIG. 8 shows an exemplary modular function composition of a computing unit configured to execute a UAV-AS according to the present disclosure;

FIG. 9 shows an exemplary modular function composition of a computing unit configured to execute a superior UAV according to the present disclosure;

FIG. 10 illustrates an exemplary cellular network architecture for LTE including a UAV and UAV-AS, which may be used according to the present disclosure;

FIG. 11 illustrates an exemplary cellular network architecture for 5G including a UAV and UAV-AS, which may be used according to the present disclosure.

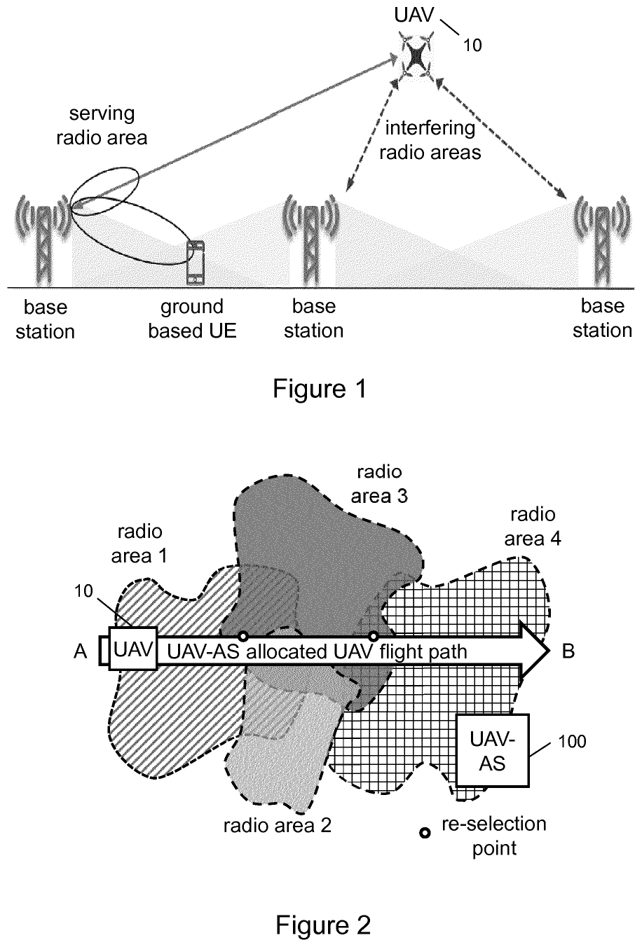

### DETAILED DESCRIPTION

In the following, a system, methods, nodes, and computer programs for an UAV to perform serving radio area re-selection while traveling and for assistance to the UAV in performing the serving radio area re-selection by an UAV-AS are described in more detail.

In the following description, for purposes of explanation and not limitation, specific details are set forth in order to provide a thorough understanding of the present disclosure. It will be apparent to one skilled in the art that the present disclosure may be practiced in other implementations that depart from these specific details. For example, while the following implementations will be described with regard to LTE and 5G architectures, it will be understood that the present disclosure shall not be limited to these architectures and that the technique presented herein may be practiced with other cellular network architectures as well. A cellular network may be a wireless network using radio-based communication towards their client.

Those skilled in the art will further appreciate that the steps, services, and functions explained herein below may be implemented using individual hardware circuitry, using software functioning in conjunction with a programmed micro-processor or general-purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories are encoded with one or more programs that perform the steps, services and functions disclosed herein when executed by the one or more processors.

Within the context of the present application, the term “Unmanned Aerial Vehicle”, or UAV in short, refers to an automatic device or machine, that can move in any given environment. UAV is considered synonym with “drone”, or “mobile robot”. Mobile robots have the capability to move around in their environment, thus they are not fixed to one physical location. In contrast, industrial robots usually consist of a jointed arm (multi-linked manipulator) and gripper assembly (or end effector) that is attached to a fixed surface while in operation. A mobile robot may be classified by the environment in which it moves:

Land or home robots are usually referred to as Unmanned Ground Vehicles. They are most commonly wheeled or tracked, but also include legged robots with two or more legs (humanoid or resembling animals or insects).
Aerial robots are usually referred to as Unmanned Aerial Vehicles, UAV.
Underwater robots are usually called Autonomous Underwater Vehicles or Unmanned Submarine Vessel.
Water surface based mobile robots are usually referred to as Unmanned Marine Vehicles.

The above listed vehicles are the types of vehicles that move autonomously, so without human pilot, on a programmed or instructed path or towards an instructed geographical position/destination or may also be steered and controlled remotely. The vehicle may also carry human passengers, but wherein none of these passengers would be involved in steering the vehicle. The vehicle may comprise a pilot or driver, but the vehicle would operate in an autonomous movement mode where the driver or pilot is released from the actual steering task.

These vehicles could operate respectively in the air, on land, underground, on sea and inland waters, in space or even on other planets/asteroids. The vehicles have an own engine respectively jet, propeller, wheel, crawler track, propeller screw, or hover propulsion and gear. The vehicles have the ability of exchanging data with each other and/or to a controlling base (such as a UAV-AS) wirelessly. A ground based cellular or wireless communication network may be employed to enable such data exchange. Such a communication network may be run by a mobile operator and thus a communication between a UAV and a controlling ground station may take place using the data communication services of that communication network.

UAV may be deployed for transportation of goods, e.g. for delivery of parcels from a reseller or shop to the end customer. They may also be used for postal services, mail delivery, or surveillance tasks.

Within the context of the present application, the term “cellular network” may denote a wireless communication network, or particularly denote a collection of nodes or entities, related transport links, and associated management needed for running a (communication) service, for example a wireless telephony service or a wireless packet transport service. Depending on the service, different node types or entities may be utilized to realize the service. A network operator owns the cellular network and offers the implemented services to its subscribers. Typical components of a wireless/cellular communication network are radio access network, RAN (such as 2G, GSM, 3G, WCDMA, CDMA, LTE, 5G, NR, WLAN, Wi-Fi), mobile backhaul network, and core network (such as GPRS Core, EPC, 5G Core).

Within the context of the present application, the term “radio area” may denote an area covered by a radio base station. That may be a radio cell, or a collection of adjacent radio cells, a location area, a routing area, or a tracking area. Within this context, a “serving radio area” is a radio area via which a UE or UAV is connected to the cellular network. If roaming outside the reach of the serving radio area, the UE/UAV must handover to a new radio area, whereby the new radio area becomes the new serving radio area. Thus, the UE/UAV must re-select the serving radio area. Typically, the selection of a new serving radio area is under control and therefore triggered by the cellular network. In order for the cellular network to trigger re-selection well before the radio strength of the serving radio area gets too weak, the UE/UAV sends periodically radio strength or radio quality reports on the radio area landscape it currently sees.

Within the context of the present application, the term “starting point”, “destination point” refers to a geographical point where the UAV may start, or respectively, land. Thus, this term refers to any geographical point that is suited to serve as a starting point for a UAV movement or as a destination point is such movement. Such starting point or destination point is typically suited to be used in a determination of a movement path between such points. For example, if a UAV is used for delivery of mail, then a starting point may be a mail delivery center that centrally collects mail for distribution, and the destination point may be a recipient of such mail that is subject for delivery. By alternative, the starting point may also be the originator of such mail, in case of direct delivery from sender to recipient. A landing point may in general be used as a starting point, or as a destination point.

Within the context of the present application, the term “flight path” refers to a traveling path of a UAV between a starting point and a destination point. It a most simple form, a flight path is a straight line between the starting point and the destination point. However, in reality a flight paths may be more complex, for example if a flight path touches a so-called no-fly zone, then the UAV is required to make a detour around such area. Traffic density or weather conditions may be other reasons to not use a straight-line flight path. In order to coordinate the flight of UAV in a geographical area, a local authority may define certain flight policies, access policies, or certain flight corridor segment definitions. Such flight policy is typically issued by an authorized (e.g. governmental) office/agency being responsible for a save and controlled usage of UAVs in that region (flight safety authority).

Such a geographical area would be characterized by the applicable flight policy and related flight corridor segment definitions being deposited in an application server, AS, and thereby made accessible for anyone deploying UAVs in that region. The AS may be physically located in that area or may be centralized (instantiated) somewhere in a remote/central data center (e.g. in a “cloud”) or may be implemented by a virtual network function. Even if the AS (or AS instance) may be distant to the geographical service area, still the geographical service area would be tied to one (logical) AS (instance), thus the AS can be queried for getting access to the applicable information.

Typically, such authorized (e.g. governmental) office/agency takes autonomous decisions on local flight policies in accordance with the local legislation. Flight policies and related flight corridor segment definitions may also comprise UAV categories (e.g. weight classes), dynamic policies (e.g. depending on time of the day or flight density in that area) or may consider access priorities (e.g. premium delivery service, or emergency/disaster recovery services).

A geographical area may also be composed of one or more sub-areas of different nature. Although the geographical service area as such is a legislative region (where a flight policy is applicable), such sub-areas may be radio coverage areas used in the cellular communication network such as tracking areas, radio cells, location areas, routing areas, or segments of a grid or geofence defined by e.g. GPS coordinates.

Thus, a flight path may be derived from such flight corridor definitions and an UAV-AS may be authorized to allocate an appropriate flight path to a UAV for traveling from a starting point to a destination point.

Referring to FIG. 2, this figure shows an illustration of UAV flight path situation when traveling from a starting point A to a destination point B, thereby crossing coverage areas of several radio areas 1 to 4.

The figure illustrates a method for assisting an UAV 10 in performing serving radio area re-selection. The UAV 10 is connected via a serving radio area to a cellular network and the UAV 10 is associated with an UAV-AS 100.

The UAV-AS 100 receives a request for allocating a flight path for use by the UAV 10 for traveling to a destination point. Thus, the flight path may be from A to B, and, as shown in this example, be crossing the radio areas 1 to 4. These radio areas are partly overlapping, and due to the fact that the UAV 10 is traveling at a higher altitude, the visibility and also the overlap of these radio areas may be different than experienced on ground level.

The request for allocating a flight path may be received from the UAV 10 or from an operator of the UAV 10. Such operator may own and run a fleet of UAV for delivering the service, such as a mail delivery service or a surveillance service. The operator may request an allocation of such flight path from the UAV-AS 100 by defining the current position “A” of the UAV 10 and also defining the scheduled destination “B” the UAV 10 is indented to travel to. By alternative, the request for allocation of a flight path may also be sent by the UAV 10 itself. In such scenario, the UAV 10 may receive an order from the UAV operator for delivering a service to a destination “B”. Then the UAV 10 would take care of requesting the appropriate flight path from the UAV-AS 100. In another alternative, the UAV 10 may pick itself an appropriate next order from a pool of available orders maintained for example by the UAV operator.

The figure also illustrates a method for performing serving radio area re-selection by an UAV 10. The UAV 10 is connected via a serving radio area to a cellular network and the UAV 10 is associated with an UAV-AS 100. The UAV 10 receives a request to travel to a destination point. Such request may be received from an operator of the UAV 10. In a next step, after the UAV-AS 100 has allocated a flight path, the UAV 10 receives a list of radio areas from the UAV-AS 100 suitable as serving radio area along the allocated flight path. While traveling along the allocated flight path, the UAV 10 then performs serving radio area re-selection to a radio area from the list of radio areas for staying connected to the cellular network.

After allocation of a flight path, the UAV-AS 100 determines a list of radio areas suitable as serving radio area along the allocated flight path. And finally, the UAV-AS 100 provides the list of radio areas to the requestor to assist the UAV 10 in performing serving radio area re-selection. The requestor may be the UAV 10 or the operator of the UAV 10.

Such a list of radio areas may list radio areas in a sequence suitable for consecutive selection as serving radio area when traveling along the allocated flight path. Thus, instead of the list being a pool of radio areas suitable for use by the UAV 10 for selection when travelling along the allocated flight path, the list may be further structured by also indicating a sequence of radio areas that would be suitable for use in the specified order. For example, the radio areas may be structured as a linked list or simply listed in consecutive order. Such additional structure allows the UAV 10 to search for the indicated next radio area to be used for re-selection, and if that radio area is detected, re-selection could be triggered by the UAV 10.

As a further option on top of the consecutive order of radio area on the list of radio areas, the list of radio areas may further comprise one or more geographical points along the allocated flight path at which the UAV 10 may perform serving radio area re-selection. This is shown as an example in the figure as small circles at certain points along the flight path. In order to further optimize the re-selection, the list may indicate not only the order in which the UAV 10 may re-select the serving radio area, but in addition also a geographical point on the flight path where the UAV 10 may perform the re-selection. Such re-selection point may be for example a GPS coordinate. In such scenario, the UAV 10 may determine the distance to that next re-selection point and suspend any search for a next radio area until close to the indicated re-selection point. The UAV-AS 100 may optimize the placement of the re-selection points. These should be placed still well enough within the current serving radio areas, so that good radio contact is still ensured. A re-selection procedure takes some time and if the UAV 10 is traveling at a higher speed and it must be avoided that the UAV 10 has already left the serving radio area before such procedure is completed. This issue increases with higher UAV travelling speeds.

Re-selection points should in addition be placed well enough in the new radio area, so that also that radio contact is ensured. In the example figure, the first re-selection point is placed well between radio area 1 and radio area 3. Radio area 1 would still be available for some time along the flight path. Radio area 3 is already available for some time, and thus a safe re-selection is ensured even if the UAV 10 was flying at a higher speed.

A determination of the list of radio areas by the UAV-AS 100 may be based on radio quality measurement information for the radio areas detectable by the UAV 10 when traveling along the allocated flight path. Thus, the UAV 10 may be sending, while traveling along the allocated flight path, a radio area measurement report to the UAV-AS 100 comprising information on detected radio areas. A UAV-AS 100 may be receiving from a UAV 10 traveling along the allocated flight path, a radio area measurement report comprising information on detected radio areas.

Such radio quality information may be based on a strength of the radio and/or an error rate determined based on previously received data. The information may comprise radio quality measurements at one or more points within the allocated flight path. Thus, the UAV 10 may measure the radio quality and report that measurement result to the UAV-AS 100 who would receive the information and may use it for determining the list of suitable radio areas.

In an alternative, the information may comprise radio quality progression information along the allocated flight path for each detected radio area, and the information is provided by the UAV 10 and received by the UAV-AS 100 after the UAV 10 has completed the allocated flight path. Thus, the UAV 10 may continuously or at certain periodical intervals perform radio quality measurements and by that produce a curve of radio quality per radio area along the flight path. At the end of the flight path, the UAV 10 may provide that measurement curve to the UAV-AS 100, who receives it. A UAV-AS 100 may utilize this measurement curve for determining the list of suitable radio areas. Having a radio quality curve at hand, the UAV-AS 100 can precisely determine optimal points for the UAV 10 to trigger a re-selection, also if a UAV is traveling at a higher speed.

In addition, or alternatively to the above radio quality information, a UAV 10 may also log if a re-selection to an indicated radio area has failed. In this case the UAV 10 may have received a list of suitable radio areas for re-selection, but a particular radio area appearing on that list would not be detectable by the UAV 10. This may be the case if there is a malfunction in the radio access network of the cellular network. Alternatively, the radio area on the list may be detectable, but a subsequent re-selection to this radio area in order to use this radio area as serving radio area may be failing. This may happen due to an error in the in the cellular network. In such a case, the UAV 10 may send information to the UAV-AS 100 on a radio area on the list of radio areas that was found not suitable as target for re-selection as serving radio area while traveling along the allocated flight path. The UAV-AS 100 may receive such information from the UAV 10. Based on such information the UAV-AS 100 may refrain from adding that radio area to lists of suitable radio areas generated in future.

In addition, or alternatively, the UAV-AS 100 may receive information on changes of an availability of a radio area or on new radio areas from an operator of the cellular network. If the operator of the cellular network gets to know a malfunction of its radio access network, he may inform the UAV-AS 100 about it. Furthermore, in case the operator of the cellular network establishes new radio areas in the radio access network, splits radio areas into two or more smaller radio areas, the UAV-AS 100 may be informed about it. In such situation, the UAV-AS 100 may provide, if the list of radio areas has changed while the UAV 10 is traveling along the allocated flight path, an updated list of radio areas to the UAV 10. The UAV 10 may receive an updated list of radio areas while traveling along the allocated flight path and replace the currently stored list of radio areas with the newly received list.

Such updated list of radio areas provided by the UAV-AS 100 to the UAV 10 may comprise only radio areas that are ahead of a current position and travelling direction of the UAV 10. This may shorten the information to be provided to the UAV 10 and simplifies the UAV 10 processing of the list.

The UAV-AS 100 may maintain a database of radio areas suitable as serving radio area, maybe even per predefined flight path. The UAV-AS 10 may keep such database up to date with radio quality reports received from a UAV 10, or information on failing radio areas received from the UAV 10, or the operator of the cellular network. Such database may even comprise pre-determined lists of suitable radio areas per flight path. For example, if a flight path from A to B is frequently used by UAVs, the UAV-AS 100 may once determine a list of suitable radio areas and store such list into the database for continuous use. The UAV-AS 100 may re-determine such lists if new information is received from a UAV 10 on malfunctioning radio areas of radio area changes from the network operator. Due to the high altitude of a UAV flight path, radio area quality reports may depend also on weather conditions and/or load in such radio area (known as “cell breathing”, i.e. a size of a radio cell depends on a load in the cell). Thus, the UAV-AS 100 may re-determine such lists at periodic time intervals, or based on weather forecast, or current radio area load reports from the network operator. Thus, the information stored in the database may be reused for further UAV flights.

Once a UAV 10 has determined that a re-selection of the serving radio area towards a radio area from the list of suitable radio areas is required, for example if a radio area from the list of radio areas is detected while traveling along the allocated flight path, the UAV 10 may perform serving radio area re-selection. Such serving radio area re-selection comprises that the UAV 10 sends a radio area measurements report to the cellular network comprising the detected radio area, the measurement report may even comprise just the next radio area as the only radio area in the report. This radio area measurements report to the cellular network may cause the cellular network to trigger a radio area re-selection procedure towards the UAV 10 to re-select to the detected radio area.

Triggering a re-selection is responsibility of the cellular network. But the UAV 10 provides radio measurement reports to the cellular network and based on these measurements the cellular network learns what radio areas the UAV 10 currently sees and how good these are. Thus, if the UAV 10 reports just the radio area that are on the received list of suitable radio areas, the cellular network has no other choice than to initiate a re-selection procedure towards the UAV 10 to steer the UAV 10 to re-select to one of the reported radio areas.

However, if the UAV 10 reports just a single radio area from the list to the cellular network, and the re-selection to that radio area fails, the UAV 10 may try to re-select other detected radio areas from that list, or, as a last resort, fallback to the standard mechanism and report all detectable radio areas, thus also radio areas that are not on the list received by the UAV 10 from the UAV-AS 100. This fallback mechanism ensures that the UAV 10 will finally always be reachable via the cellular network, allowing the UAV-AS 100 to recover control on the UAV 10 at all times.

The UAV-AS 100 determines a list of suitable radio areas for use by the UAV 10 when travelling along the allocated flight path. Such determination of a list of radio areas may comprise adding one or more radio areas to the list of radio areas that allow the UAV 10 to minimize a number of serving radio area re-selections when traveling along the allocated flight path. Since travelling at a higher altitude, radio area may be visible for a longer time than perceived by a ground-based UE. Thus, some intermediate radio areas may be skipped along the flight path, if the next radio area becomes accessible early enough.

This principle is further explained in an example in FIG. 2. The radio areas 1 to 4 are partly overlapping. Thus, when travelling along the allocated flight path, the UAV 10 may first detect radio area 1. Then, for a short period of time, radio area 3 may become visible in addition to radio area 1. After that, radio area 2 may be detected, in addition to radio areas 1 and 3. However, radio area 1 and 2 would fade away and there is a short range, where only radio area 3 would be reachable. Then radio area 4 is detected and later on radio area 3 would fade away. Radio area 4 is then the only radio area available up to the destination.

Thus, a possible sequence of radio area re-selections could be (in short format):

1^{st} alternative: 1=>3=>2=>3=>4.

Alternatively, the UAV may also perform a re-selection sequence:

2^{nd} alternative: 1=>2=>3=>4.

Finally, the UAV may also perform a re-selection sequence of:

3^{rd} alternative: 1=>3=>4

The 3^{rd} alternative of re-selection sequence does clearly involve the least radio areas and requires just two re-selections along the flight path, being clearly the minimum of a number of serving radio area re-selections when traveling along the allocated flight path.

Alternatively, or in addition, the UAV-AS may consider information of a type or size of a radio area. A radio access network of a cellular network is typically designed to comprise so called macro radio areas (macrocells), which are indented to cover a larger area (an “overlay” radio area) and smaller radio areas (microcells), that cover hot spots where more capacity is needed or where the radio of the macro radio area would be shaded due to obstacles. A macro radio base station antenna could have a more exposed position and/or transmit using a higher power to achieve the larger coverage. The operator of the cellular network may provide such information of the type/size of the radio areas to the UAV-AS 100, or the UAV-AS 100 may derive such classification from the radio quality measurement reports of the UAV 100. Thus, when determining a list of radio areas, the UAV-AS 100 may prioritize macro radio areas over micro radio areas.

Alternatively, or in addition, a determination of a list of radio areas may comprise determining, whether the allocated flight path can be covered by a single radio area, and if so, adding only this radio area to the list of radio areas. This step covers the scenario that a flight path would entirely take place within the coverage of one radio area. This may be the case for short range flights. For such case, no re-selection may be needed along the allocated flight path.

However, if the allocated flight path cannot be covered by a single radio area, the UAV-AS 100 may determine a table of all permutations of radio area combinations that cover the allocated flight path. In the above example, three alternative re-selection sequences cover the entire flight path, thus the UAV-AS 100 may build up a table comprising these three permutations.

Finally, the UAV-AS 100 may add the radio area combination to the list of radio areas that comprises a least number of different radio areas. As shown in the above example, this is clearly the case for the third alternative.

The determined list of radio areas is then provided from the UAV-AS 100 to the UAV 10. As described above, such determination may be performed by the UAV-AS 100 also periodically and the result is stored in the database.

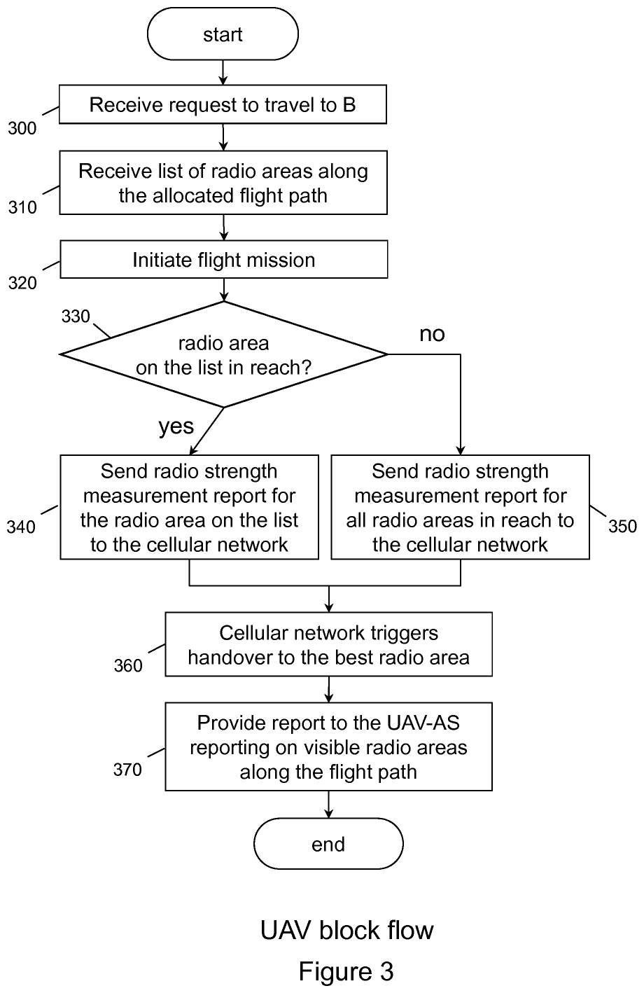

Referring to FIG. 3, this figure shows a block diagram in a UAV for serving radio area re-selection when traveling from a starting point to a destination point. The UAV may correspond to an UAV 10 as shown in the previous figures.

The flow starts in step 300, if the UAV receives a request to travel to destination point B. The request may also comprise a starting point A, for example if A is not identical with the current position of the UAV. Such request may be received from an operator of the UAV. The request may comprise an allocated flight path to destination B.

In step 310 the UAV receives a list of radio areas along the allocated flight path, these radio areas would be suitable for use as serving areas when traveling along the allocated flight path. Such list of radio areas may be received together with the allocated flight path from a UAV-AS, or the UAV may request such list separately from the flight path allocation step.

Then in step 320 the UAV may initiate the flight mission along the allocated flight path towards the destination B.

While travelling along the allocated flight path, the UAV may continuously, or at certain time intervals, monitor the radio environment. For example, the radio areas on the list may be sorted in consecutive order of appearance along the flight path. Thus, in such example, the UAV may exactly know which radio area to scan for. So, in step 330, the UAV determines whether the next radio area on the list would be detectable and comes into reach of the UAV. If the next radio area is detected, in step 340, the UAV sends a radio measurement report comprising only that radio area to the cellular network. Alternatively, if the UAV fails to detect the expected next radio area on the list, although that rea should already be in reach, in step 350, the UAV falls back to the normal radio area reporting mode of reporting all radio areas to the cellular network that are detectable.

In step 360 the cellular network may trigger a serving radio area re-selection or handover procedure, causing the UAV to perform that re-selection/handover. The target radio area is set by the cellular network and is based on the radio measurement reporting from the UAV. Thus, if the UAV has reported just a single radio area from the list, such trigger from the cellular is to re-select/handover to that radio area. If the UAV has reported more than one radio area to be in reach, the cellular network will decide on the target radio area.

In step 370 the UAV reports radio quality measurement to the UAV-AS. Such reporting to the UAV-AS may be done at certain time intervals, distances of flight, or if the radio conditions changes. Alternatively, the UAV may report a radio quality progression report for each of the radio areas it sees when travelling along the allocated flight path. Such progression curve may be reported at the very end of the flight mission when reaching, or shortly before reaching, the destination B.

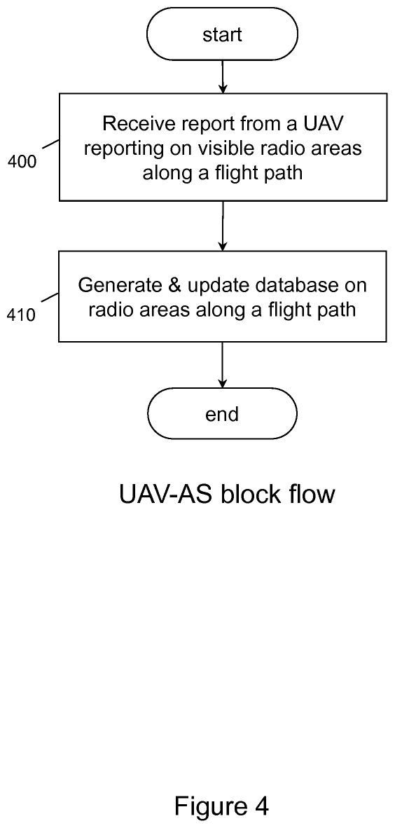

Referring to FIG. 4, this figure shows a first block diagram in a UAV-AS for receiving measurement reports from a UAV while traveling and maintain a database. The UAV-AS may correspond to an UAV-AS 100 as shown in the previous figures.

The flow starts in step 400 when the UAV-AS receives a reporting from a UAV reporting on radio quality measurements while travelling along an allocated flight path. As described above, such reporting from the UAV to the UAV-AS may be done at certain time intervals, distances of flight, or if the radio conditions change. Alternatively, the UAV may report a radio quality progression report for each of the radio areas it sees when travelling along the allocated flight path. Such progression curve may be reported at the very end of the flight mission when reaching the destination B.

In step 410 the UAV-AS stores the received radio quality measurement information in a database and thereby builds up information knowledge on the radio environment along all flight paths. By continuously storing and updating the information in the database, the UAV-AS has enough information at hand to determine a list of suitable radio areas along a flight path. The process of steps 400 and 410 ensures that the database is always up to date with the currently available radio areas, and their current coverage.

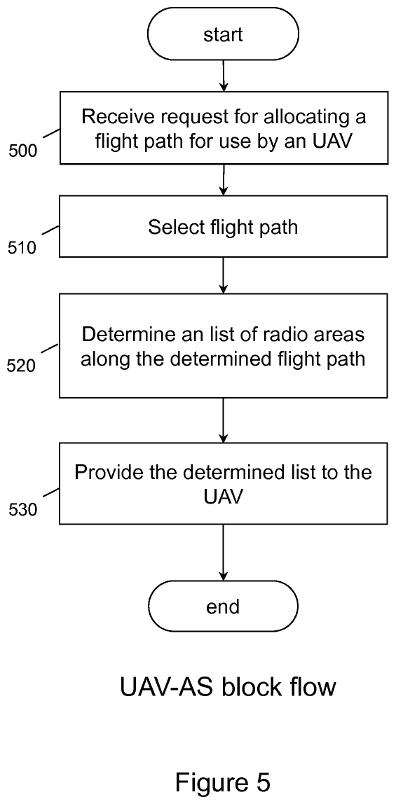

Referring to FIG. 5, this figure shows a second block diagram in a UAV-AS for assisting a UAV in radio area re-selection while traveling. The UAV-AS may correspond to an UAV-AS 100 as shown in the previous figures.

The flow starts in step 500 when the UAV receives a request for allocating a flight path to a destination B for use by an UAV. Such request may originate from an operator of UAVs, or directly from an UAV selected for traveling to the destination B.

In step 510 the UAV-AS decides on the flight path the UAV shall follow when travelling to the destination B. The UAV-AS may also allocate capacity (a flight slot) in that selected flight path. The UAV-AS may utilize well known algorithms in such selection and allocation steps, for example by avoiding no-fly zones, selection of flight segments with enough space to cope with the UAV, or by a concatenation of pre-defined flight corridor segments defined by a local flight safety authority.

In step 520 the UAV-AS may determine a list of radio areas suitable to be used as serving radio areas along the flight path as selected and allocated in step 510.

As already described above, the UAV-AS may select radio areas that allow the UAV to minimize a number of radio area re-selections when travelling along the allocated flight path towards the destination B.

Finally, in step 530, the UAV-AS provides the determined list of radio areas to the requestor, thus to the operator of the UAV, who then may forward it to the UAV, or to the UAV directly. Such provisioning may be done together with the information on the allocated flight path, or separately from such information.

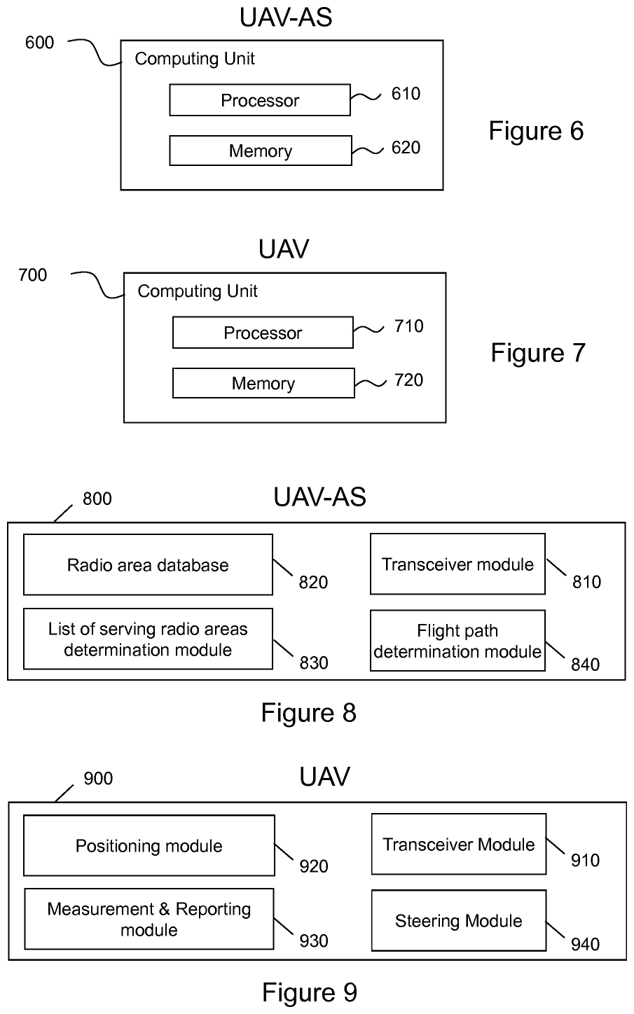

Referring to FIG. 6, this figure shows an exemplary composition of a computing unit configured to execute a UAV-AS according to the present disclosure. The UAV-AS may correspond to an UAV-AS 100 as shown in the previous figures.

The computing unit 600 comprises at least one processor 610 and at least one memory 620, wherein the at least one memory 620 contains instructions executable by the at least one processor 610 such that the computing unit 600 is operable to carry out the method steps described in FIG. 4 or 5 with reference to the UAV-AS 100.

Referring to FIG. 7, this figure shows an exemplary composition of a computing unit configured to execute a UAV according to the present disclosure. The UAV may correspond to an UAV 10 as shown in the previous figures.

The computing unit 700 comprises at least one processor 710 and at least one memory 720, wherein the at least one memory 720 contains instructions executable by the at least one processor 710 such that the computing unit 700 is operable to carry out the method steps described in FIG. 3 with reference to the UAV 10.

It will be understood that the computing units 600 and 700 may be physical computing units as well as virtualized computing units, such as virtual machines, for example. It will further be appreciated that the computing units may not necessarily be implemented as standalone computing units but may be implemented as components—realized in software and/or hardware—residing on multiple distributed computing units as well.

Referring to FIG. 8, this figure shows an exemplary modular function composition of a computing unit configured to execute a UAV-AS according to the present disclosure. The UAV-AS may correspond to an UAV-AS 100 as shown in the previous figures. The UAV-AS may comprise a Transceiver Module 810, a Radio Area Database 820, a Radio Area List Determination Module 830, and Flight Path Determination Module 840.

The Transceiver Module 810 may be adapted to perform reception and sending of request/response messages, such as step 400, 500, 530, and any signaling messages related to assisting a UAV in performing serving radio area re-selection.

The Radio Area Database 820 may be adapted to store radio quality measurements as received from UAV while travelling along allocated flight paths. The radio quality measurements may be stored in a structured way, for example the measurements may be classified by measurements in a certain altitude, per particular radio area, geographical position, or UAV travelling speed. This allows the UAV-AS to generate a three-dimensional picture of the coverage range of the radio areas. The UAV-AS may keep the database up to date when condition change or new information is received by the UAV-AS. The Radio Area Database 820 may be consulted for the latest status on radio coverage of the radio areas within the responsibility area of the UAV-AS. The database may also store determined lists of radio areas suitable for use along a given flight path, the database may store such lists per commonly used flight paths or pre-defined flight corridors. The database may be used by the Determination Module 830 for determination of radio area lists.

The Determination Module 830 for determination of serving radio area lists may be adapted to determine such lists. For this purpose, the module may interact with the database 820 for providing either pre-determined lists of radio areas per flight path or for accumulated providing radio quality measurements per radio area and per flight path. The determination module may determine the radio areas on a list such that the UAV may minimize the number of serving radio area re-selections or handovers.

The Flight Path Determination Module 840 may be adapted to determine on request a flight path that best meets for example the request demands, the current flight density situation, and flight safety authority demands in the responsibility area of the UAV-AS. Once a flight path is selected or determined, the Module 840 may also allocate the flight path to the UAV by reserving capacity in the respective flight path. The result may also be stored for a later reuse, for example in the database 820.

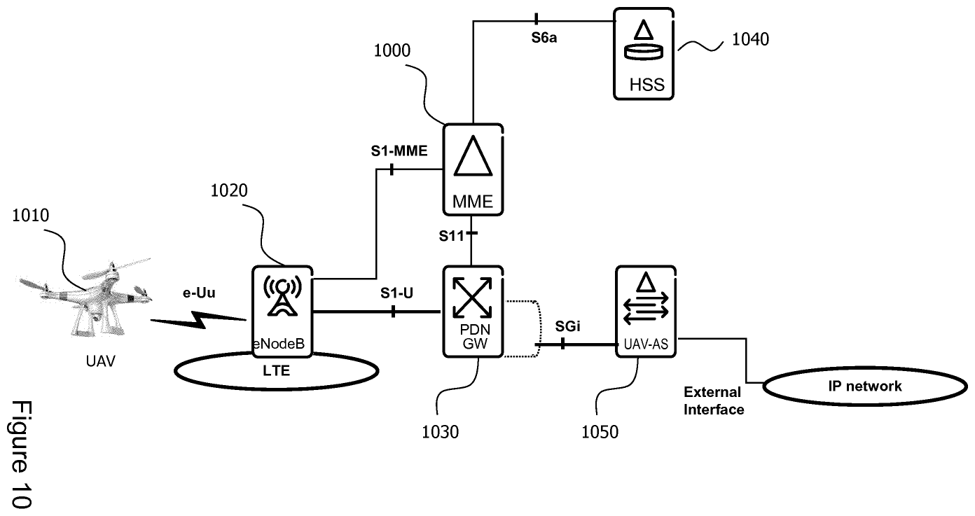

Referring to FIG. 9, this figure shows an exemplary modular function composition of a computing unit configured to execute a UAV according to the present disclosure. The UAV may correspond to an UAV 10 as shown in the previous figures. The UAV may comprise a Transceiver Module 910, a Positioning Module 920, a Measurement & Reporting Module 930, and a Steering Module 940.

The Transceiver Module 910 may be adapted to perform reception and sending of request/response messages, such as step 300, 310, 370, and any signaling messages related to performing serving radio area re-selection while traveling.

The Positioning Module 920 may be adapted to determine the current own position of the UAV, e.g. the GPS coordinates and an altitude. The module may also determine its position based on triangulation of known radio transmitter and a perceived radio strength. The module may also utilize positioning services of the cellular network to determine the own position. Depending on the accuracy needs, different positioning methods may be used to complement each other, to verify the result, or to shorten the determination time. The UAV may detect approaching radio area re-selection points as indicated in a list of radio areas.

The Measurement & Reporting Module 930 may be adapted to measure radio quality at a current position and collect radio quality measurements along an allocated flight path, per detected radio areas. The module 930 may utilize the Transceiver Module 910 for providing the radio quality measurements at a particular/current position, or a radio quality progression curve of radio areas, to the responsible UAV-AS. The module may also scan for radio areas detectable from the UAV at the current position. In this way, the UAV may determine whether a radio area of the radio areas on the list, or whether a next radio area on the list gets into reach. The module may also be used for producing radio strength measurement reports to the cellular network. Based on such measurement reports, the cellular network may determine to initiate a serving radio area re-selection procedure towards the UAV.

The Steering Module 940 may be adapted to control the UAV movement along a given flight path. The module may use data from the Positioning Module 920 and sensors to determine corrective actions for the UAV to move in accordance with the requirements of an allocated flight path.

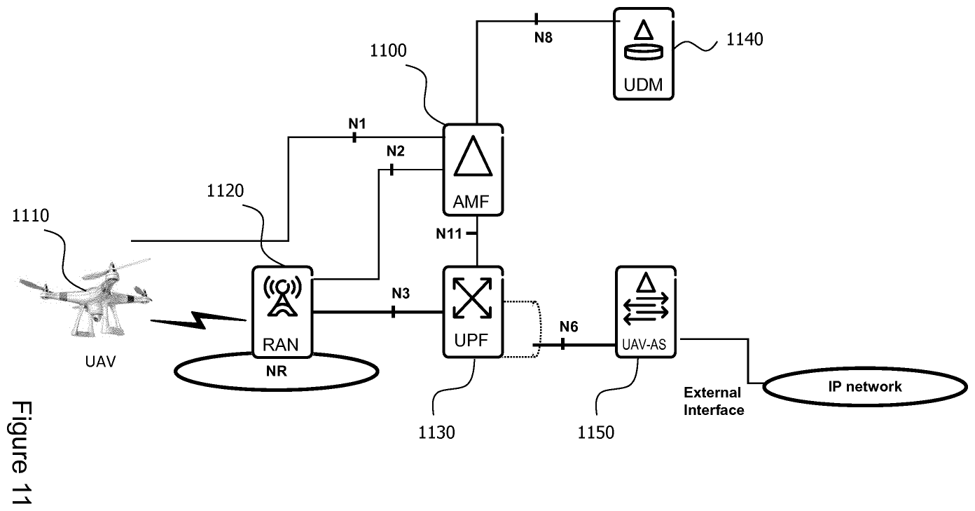

Referring to FIG. 10, this figure illustrates exemplary cellular network architecture for LTE including a UAV and UAV-AS, which may be used according to the present disclosure.

A radio coverage area of an LTE network is based on tracking areas. In such example, the geographical service area a UAV-AS is responsible for, may be constructed from one or more tracking areas of the LTE radio network. The UAV may comprise a LTE-radio module (and a type of subscriber identity module, SIM, card) which is used to register the UAV into the packet core network of the network operator. Once being registered, or as part of the registration procedure, the UAV may discover the UAV-AS being responsible for the current geographical service are. The normal mobility procedures of the packet core network are used to keep track on the mobility of the UAV. This architecture is sketched in this figure in more detail.

As common LTE architectures, the architecture shown in this figure comprises an eNodeB 1020 through which the UAV 1010 may connect to the cellular network using an e-Uu interface. The eNodeB 1020 connects to a Mobility Management Entity, MME, 1000 for control plane support using an S1-MME interface and to a Packet Data Network Gateway, PDN GW, 1030 for user plane support (i.e., for user data transfer) using an S1-U interface. The MME 1000, in turn, is connected to a Home Subscriber Service, HSS, 1040 containing user-related and subscription-related information via an S6a interface. It will be understood by the skilled person that the architecture shown in this figure corresponds to a simplified LTE architecture in which only those components that are necessary for the purpose of elucidating the technique presented herein are shown.

In addition to the above-described common entities of an LTE network, the architecture illustrated in this figure further comprises a UAV application server 1050 (denoted as “UAV-AS” in the figure) as part of the cellular communication network. The UAV-AS 1050 may correspond to the UAV-AS described in relation to the previous figures. The UAV-AS 1050 connects to the PDN GW 1030 through an SGi interface and supports an external interface which allows access to functions of the UAV-AS 1050 to entities external to the cellular communication network, such as entities accessing the UAV-AS 1050 from the Internet, or vice versa, for example.

Using the SGi interface to the packet core network, the UAV-AS can communicate with the UAV and vice versa. This allows to instruct a flight policy or corresponding actions to a UAV and to receive flight path information from the UAV in the UAV-AS. Via the interface to external networks such as the Internet, the UAV-AS is able to retrieve and provide information from an operator of the UAV, or to contact other UAV-AS of a hierarchical UAV-AS architecture.

Referring to FIG. 11, this figure illustrates exemplary cellular network architectures for 5G including a UAV and UAV-AS, which may be used according to the present disclosure.

The architecture shown in this figure corresponds to a 5G variant of the architecture described in relation to FIG. 10. The basic principles for practicing the technique presented herein may equally apply to the 5G architecture of this figure. Unnecessary repetitions are thus omitted in the following. Only, it is noted that the functions described above for the eNodeB, the MME, the PDN GW and the HSS may in this case be performed by corresponding functions of the 5G architecture, i.e., the Radio Access Network, RAN, 1120, the Access and Mobility Function, AMF, 1100, the User Plane Function, UPF, 1130, and the User Data Management, UDM, 1140, respectively.

According to another embodiment, a computer program is provided. The computer program may be executed by the processors 610 or 710 of the above-mentioned entities UAV-AS or UAV respectively such that a method for an UAV to perform serving radio area re-selection while traveling and for assistance to the UAV in performing the serving radio area re-selection by an UAV-AS as described above with reference to FIG. 3, 4, or 5 may be carried out or be controlled. The entities UAV-AS or UAV may be caused to operate in accordance with the above described method by executing the computer program.

The computer program may be embodied as computer code, for example of a computer program product. The computer program product may be stored on a computer readable medium, for example a disk or the memory 620 or 720 of the UAV-AS or UAV, or may be configured as downloadable information.

One or more embodiments as described above may enable at least one of the following technical effects:
reduced number of handover or radio area re-selections for a flight path from location A to location B
unnecessary handover or radio area re-selections are avoided, and disturbance of the cellular network is minimized, also reducing the signaling load
allowing a higher travel speed of the UAV
the UAV-AS learns dynamically the radio area visibility in certain altitude over time and makes dynamically use of this information
re-usage of existing network capabilities without impacting a deployed cellular network or 3GPP signaling procedure definitions
maybe required by national flight regulation authorities in future

Modifications and other embodiments of the disclosed invention will come to mind to one skilled in the art having the benefit of the teachings presented in the foregoing descriptions and the associated drawings. Therefore, it is to be understood that the embodiments are not to be limited to the specific embodiments disclosed and that modifications and other embodiments are intended to be included within the scope of this disclosure. Although specific terms may be employed herein, they are used in a generic and descriptive sense only and not for purposes of limitation.

1-32. (canceled)

33. A method for assisting an unmanned aerial vehicle (UAV) in performing serving radio area re-selection, the UAV being connected via a serving radio area to a cellular network and further being associated with an UAV-Application Server (UAV-AS), the method being performed by the UAV-AS and comprising:
receiving a request from a requestor, for allocating a flight path for use by the UAV for traveling to a destination point;
determining, after allocation of the allocated flight path, a list of radio areas suitable as serving radio areas along the allocated flight path; and
providing the list of radio areas to the requestor to assist the UAV in performing serving radio area re-selection.

34. The method of claim 33, wherein the list of radio areas lists radio areas in a sequence suitable for consecutive selection as respective serving radio areas when traveling along the allocated flight path.

35. The method of claim 34, wherein the list of radio areas further indicates one or more geographical points along the allocated flight path at which the UAV shall perform serving radio area re-selection.

36. The method of claim 33, wherein determination of the list of radio areas is based on radio quality measurement information for radio areas detectable when traveling along the allocated flight path.

37. The method of claim 33, wherein determining the list of radio areas comprises choosing which radio areas of the cellular network to include in the list, so as to minimize serving radio area reselections needed for the UAV with respect to maintaining connectivity with the cellular network while traveling along the allocated flight path.

38. The method of claim 33, wherein the UAV-AS maintains a database of radio areas suitable as serving radio areas per predefined flight path, among one or more predefined flight paths, including the allocated flight path.

39. The method of claim 38, wherein the database is determined based on radio measurement reports provided by one or more given UAVs while traversing one or more predefined flight paths, the allocated flight path being one of the one or more predefined flight paths, and the radio measurement reports indicating radio signal measurements made by the one or more given UAVs with respect to radio areas of the cellular network that were detected by the one or more UAVs while traversing the one or more predefined flight paths.

40. The method of claim 33, further comprising receiving, from the UAV while traveling along the allocated flight path, information on one or more of the radio areas in the list of radio areas that the UAV found not suitable as targets for serving radio area re-selection.

41. The method of claim 40, further comprising providing an updated list of radio areas to the UAV while the UAV is traveling along the allocated flight path, responsive to determining that there are radio-area changes along the allocated flight path.

42. The method of claim 33, wherein the requestor is the UAV.

43. A method for performing serving radio area re-selection by an unmanned aerial vehicle (UAV), the UAV being associated with an UAV-Application Server (UAV-AS), the method being performed by the UAV and comprising:
receiving, from the UAV-AS after a flight path has been allocated to the UAV for traveling to a destination point, a list of radio areas of the cellular network that are suitable by the UAV as serving radio areas while traveling along the allocated flight path; and
performing serving radio area re-selection according to the list of radio areas, for staying connected to the cellular network while traveling along the allocated flight path.

44. The method of claim 43, wherein the list of radio areas lists radio areas in a sequence suitable for consecutive selection as respective serving radio areas when traveling along the allocated flight path.

45. The method of claim 44, wherein the list of radio areas further indicates one or more geographical points along the allocated flight path at which the UAV shall perform serving radio area re-selection.

46. The method of claim 43, wherein performing serving radio area re-selection comprises sending radio measurement reports to the cellular network in response to detecting respective ones of the listed radio areas, wherein the cellular network triggers serving radio area reselection by the UAV between respective ones of the listed radio areas, in dependence on corresponding ones of the radio measurement reports.

47. The method of claim 43, further comprising sending radio measurement information after completing the allocated flight path, indicating radio measurements made by the UAV for detected radio areas of the cellular network, as detected by the UAV at one or more points along the allocated flight path.

48. The method of claim 43, further comprising sending information to the UAV-AS for one or more listed radio areas that were found not suitable by the UAV as targets for radio serving area re-selection.

49. The method of claim 48, further comprising receiving an updated list of radio areas while traveling along the allocated flight path and replacing the list of radio areas with the updated list.

50. An Application Server (UAV-AS) operative to assist an unmanned aerial vehicle (UAV) in performing serving radio area re-selection, the UAV-AS comprising:
a transceiver; and
processing circuitry configured to:
receive, via the transceiver, a request from a requestor, for allocating a flight path for use by the UAV for traveling to a destination point;
determine, after allocation of the flight path, a list of radio areas suitable for use by the UAV as serving radio areas of a cellular network, for maintaining connectivity by the UAV to the cellular network as the UAV travels along the allocated flight path; and
send the list of radio areas to the requestor, for assisting the UAV in performing serving radio area re-selection.

51. An unmanned aerial vehicle (UAV) operative to perform serving radio area re-selection, the UAV being associated with an UAV-Application Server (UAV-AS), the UAV comprising:
a transceiver; and
processing circuitry configured to:
receive, via the transceiver, signaling indicating a list of radio areas determined by the UAV-AS and corresponding to a flight path allocated to the UAV for traveling to a destination point, the list of radio areas indicating radio areas of a cellular network suitable for use by the UAV as serving radio areas while the UAV travels along the allocated flight path; and
perform serving radio area re-selection while the UAV travels along the allocated flight path, according to the list of radio areas.
